(19) United States
(12) Patent Application Publication
(10) Pub. No.: US 2025/0245839 A1
(43) Pub. Date: Jul. 31, 2025

(54) TARGET RECOGNITION METHOD AND APPARATUS, DEVICE, AND STORAGE MEDIUM

(71) Applicant: Hainan University, Haikou (CN)

(72) Inventors: Rongnian TANG, Haikou (CN); Cheng QIAN, Haikou (CN); Chuang LI, Haikou (CN); Xiaofeng XIE, Haikou (CN); Wenfeng HU, Haikou (CN); Chengkang TANG, Haikou (CN); Qunfu ZHOU, Haikou (CN)

(21) Appl. No.: 19/022,381

(22) Filed: Jan. 15, 2025

(30) Foreign Application Priority Data
Jan. 30, 2024 (CN) 202410124058.0

(51) Int. Cl. G06T 7/20; G06T 5/70; G06T 7/10

(52) U.S. Cl. CPC G06T 7/20; G06T 5/70; G06T 7/10; G06T 2207/30241

(57) ABSTRACT

This application provides a target recognition method and apparatus, a device, and a storage medium. The method includes: performing, by using a preset visual sensor, event signal collection on a target object to obtain a target event signal; performing a slice division operation on the target event signal based on a preset time interval to obtain a signal sample; and performing a graph construction operation on the signal sample based on an event timestamp and a target nearest neighbor algorithm to obtain a distance relationship graph of the signal sample, and performing density clustering on the distance relationship graph to recognize the target object. In this way, graph construction is performed based on characteristics of event data, and a density clustering algorithm is used to perform target recognition and detection on a constructed graph, so that effect of dynamic recognition is achieved through iterative calculation on different time slices.

### CROSS REFERENCE TO RELATED APPLICATION

This patent application claims the benefit and priority of Chinese Patent Application No. 202410124058.0, filed with the China National Intellectual Property Administration on Jan. 30, 2024, the disclosure of which is incorporated by reference herein in its entirety as part of the present application.

### TECHNICAL FIELD

The present disclosure relates to the technical field of signal recognition, and in particular, relates to a target recognition method and apparatus, a device, and a storage medium.

### BACKGROUND

An event-triggered asynchronous visual sensor is generally referred to as an event camera, and is a new type of bionic visual sensor. Each photosensitive pixel of the event-triggered asynchronous visual sensor works independently, and data output by the photosensitive pixel is in a form of event stream signal. The signal is in a discrete state in a three-dimensional time-space domain and presents a point cloud data state, so that the event signal does not include features such as a texture and a color of a general image.

Compared with a conventional frame camera, the event camera has many advantages such as low latency, low power consumption, a high dynamic range, and small motion blur. The event camera is configured to asynchronously collect a data signal based on a light intensity change, and an event is only triggered when the light intensity change exceeds a pixel threshold, while the frame camera is configured to synchronously collect an entire image. Data output by the event camera is a sparse and asynchronous event stream, and cannot be directly processed through a standard visual channel, for example, an architecture based on a conventional neural network (CNN). Therefore, during target recognition, some new methods need to be considered to process the data output by the event camera.

### SUMMARY

In view of this, an objective of the present disclosure is to provide a target recognition method and apparatus, a device, and a storage medium, to implement effect of dynamically recognizing a target object. The present disclosure adopts the following specific technical solutions.

According to a first aspect, this application discloses a target recognition method, including:
performing, by using a preset visual sensor, event signal collection on a target object to obtain a target event signal;
performing a slice division operation on the target event signal based on a preset time interval to obtain a signal sample; and
performing a graph construction operation on the signal sample based on an event timestamp and a target nearest neighbor algorithm to obtain a distance relationship graph of the signal sample, and performing density clustering on the distance relationship graph to recognize the target object.

Optionally, the performing, by using a preset visual sensor, event signal collection on a target object to obtain a target event signal includes:
performing, by using the preset visual sensor, the event signal collection on the target object to obtain a target event stream; and
performing data simplification on the target event stream based on event pixel coordinates and the event timestamp to obtain a simplified data signal, and performing data denoising on the simplified data signal to obtain the target event signal.

Optionally, the performing, by using a preset visual sensor, event signal collection on a target object to obtain a target event signal includes:
performing, by using the preset visual sensor, the event signal collection on the target object to obtain an initial event signal; and
converting an event format of the initial event signal into a list form, to obtain the target event signal.

Optionally, the performing a slice division operation on the target event signal based on a preset time interval to obtain a signal sample includes:
performing the slice division operation on the target event signal based on the preset time interval and along the event timestamp in the target event signal to obtain the signal sample.

Optionally, before the performing a graph construction operation on the signal sample based on an event timestamp and a target nearest neighbor algorithm to obtain a distance relationship graph of the signal sample, the method further includes:
setting a distance formula and a K value in an initial nearest neighbor algorithm to obtain the target nearest neighbor algorithm, where the distance formula is a Euclidean distance formula.

Optionally, before the performing a graph construction operation on the signal sample based on an event timestamp and a target nearest neighbor algorithm to obtain a distance relationship graph of the signal sample, the method further includes:
sequentially performing the graph construction operation constructed by iterative calculation on each signal sample based on the event timestamp and the target nearest neighbor algorithm to obtain the distance relationship graph of each signal sample.

Optionally, the performing density clustering on the distance relationship graph to recognize the target object includes:
performing density clustering on the distance relationship graph based on a density-based spatial clustering of applications with noise (DBSCAN) algorithm to recognize the target object.

According to a second aspect, this application discloses a target recognition apparatus, including:
a signal collection module, configured to perform, by using a preset visual sensor, event signal collection on a target object to obtain a target event signal;
a signal division module, configured to perform a slice division operation on the target event signal based on a preset time interval to obtain a signal sample; and
a target recognition module, configured to: perform a graph construction operation on the signal sample based on an event timestamp and a target nearest neighbor algorithm to obtain a distance relationship graph of the signal sample, and perform density clustering on the distance relationship graph to recognize the target object.

According to a third aspect, this application provides an electronic device, including:
a memory, configured to store a computer program; and
a processor, configured to execute the computer program to implement the target recognition method.

According to a fourth aspect, this application discloses a computer-readable storage medium, where the computer-readable storage medium is configured to store a computer program, and when the computer program is executed by a processor, the target recognition method is implemented.

It can be seen that, in this application, the preset visual sensor is used to perform event signal collection on the target object to obtain the target event signal; the slice division operation is performed on the target event signal based on the preset time interval to obtain the signal sample; and the graph construction operation is performed on the signal sample based on the event timestamp and the target nearest neighbor algorithm to obtain the distance relationship graph of the signal sample, and density clustering is performed on the distance relationship graph to recognize the target object. In other words, slicing at a fixed time interval is performed according to the timestamp, a graph is reconstructed based on divided event data to reconstruct an image, and the density clustering algorithm is performed on a reconstructed graph for characteristic clustering of the target object, so that the recognition on the target object is accomplished. In this way, a density-clustering machine learning algorithm is adopted during target recognition, and recognition on a dynamic target is implemented through iterative calculation at fixed time slices, so that a utilization rate of the preset visual sensor is greatly increased.

### BRIEF DESCRIPTION OF THE DRAWINGS

To describe the technical solutions in the embodiments of the present disclosure or in the prior art more clearly, the drawings required for describing the embodiments or the prior art will be briefly described below. Apparently, the drawings in the following description merely show the embodiments of the present disclosure, and those of ordinary skill in the art can still derive other drawings from the provided drawings without creative efforts.

FIG. 1 is a flowchart of a target recognition method according to this application;

FIGS. 2A-2B are the demonstration of a specific target recognition method according to this application;

FIG. 3 is a flowchart of a specific target recognition method according to this application;

FIG. 4 is a flowchart of a specific target recognition method according to this application;

FIG. 5 is a flowchart of a target recognition apparatus according to this application; and

FIG. 6 is a schematic diagram of a structure of an electronic device according to this application.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by a person of ordinary skill in the art based on the embodiments of the utility model without creative efforts shall fall within the protection scope of the utility model.

An event signal is in a discrete form in a time-space domain, and is different from a conventional frame image signal in form. A target recognition algorithm for a conventional frame image signal is not applicable to the event signal. Therefore, a target recognition algorithm for the event signal is specifically described in this application.

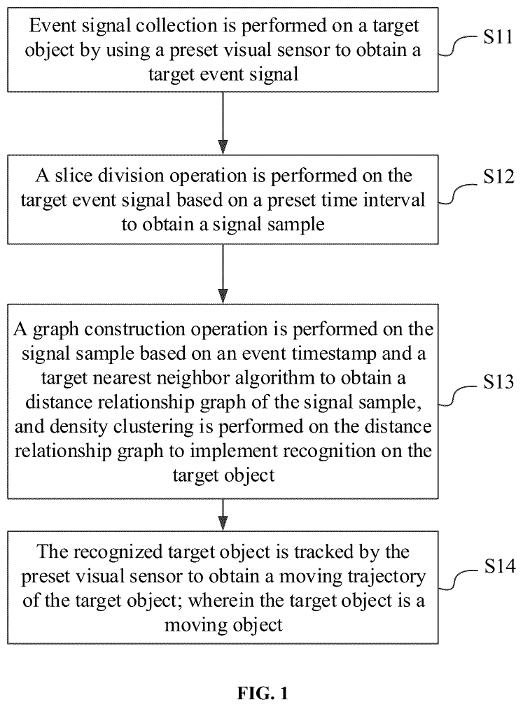

Refer to FIG. 1. An embodiment of this application discloses a target recognition method, including the following steps.

In step S11, event signal collection is performed on a target object by using a preset visual sensor to obtain a target event signal.

In a specific embodiment, that event signal collection is performed on a target object by using a preset visual sensor to obtain a target event signal includes: The event signal collection is performed on the target object by using the preset visual sensor to obtain a target event stream; and data simplification is performed on the target event steam based on event pixel coordinates and an event timestamp to obtain a simplified data signal, and data denoising is performed on the simplified data signal to obtain the target event signal. In other words, the event signal is collected by using the preset visual sensor, and the event signal is denoised to reduce noise interferences. It should be noted that, the preset visual sensor is also referred to as an event camera. To be specific, the target object is recorded by the event camera, and each event point in an event steam (e)ₜ₌₁^{N} output by the event camera is represented as eᵢ=(tᵢ, xᵢ, yᵢ), where (xᵢ, yᵢ) represents pixel coordinates of an event, tᵢ represents an event timestamp, and pᵢ=∈{0, 1} represents event polarity. Only vᵢ=(tᵢ, xᵢ, yᵢ) is considered for output event data, and simplified data is denoised to obtain the target event signal.

In another specific embodiment, that event signal collection is performed on a target object by using a preset visual sensor to obtain a target event signal includes: The event signal collection is performed on the target object by using the preset visual sensor to obtain an initial event signal; and an event format of the initial event signal is converted into a list form, to obtain the target event signal. To be specific, a computer is connected to the event camera to collect an event, an output event format is converted into readable event data, and the data is denoised to output a list form of the event, to obtain the target event signal.

In step S12, a slice division operation is performed on the target event signal based on a preset time interval to obtain a signal sample.

In this embodiment, that a slice division operation is performed on the target event signal based on a preset time interval to obtain a signal sample includes: The slice division operation is performed on the target event signal based on the preset time interval and along the event timestamp in the target event signal to obtain the signal sample. To be specific, slicing according to time Δt is performed in the time-space domain of the event data, the target event signal is divided according to a fixed time interval along the timestamp, and data obtained through division form a single independent small sample Ni. In this application, Δt=20 ms. In a specific implementation process, Δt can be adjusted and set according to a practical condition.

In step S13, a graph construction operation is performed on the signal sample based on the event timestamp and a target nearest neighbor algorithm to obtain a distance relationship graph of the signal sample, and density clustering is performed on the distance relationship graph to recognize the target object. In step S14, the recognized target object is tracked by the preset visual sensor to obtain a moving trajectory of the target object; wherein the target object is a moving object.

In this embodiment, after identifying the target object, event signals may be continuously collected from the target object by the preset visual sensor, and the above target recognition method may be executed by a program run on a computer to identify the positions of the target object at different moments, so as to obtain a precise moving trajectory of the target object. Wherein the target object is a moving object, which may be, for example, a fast-moving vehicle or a moving body such as a ball. When the target object is a vehicle, the speed of the vehicle can be obtained from the positions of the vehicle at different moments, and the speed of the vehicle can be monitored, which can then be applied in the field of monitoring of vehicle speeding.

The target recognition method of the present application can recognize a fast-moving target object; the moving trajectory of the fast-moving target object can be obtained through the measurement of the position of the target object at different moments.

In this embodiment, before the graph construction operation is performed on the signal sample based on the event timestamp and the target nearest neighbor algorithm to obtain the distance relationship graph of the signal sample, the method further includes: A distance formula and a K value are set in an initial nearest neighbor algorithm to obtain the target nearest neighbor algorithm, where the distance formula is a Euclidean distance formula. That a graph construction operation is performed on the signal sample based on the event timestamp and a target nearest neighbor algorithm to obtain a distance relationship graph of the signal sample includes: The graph construction operation constructed by iterative calculation is performed on each signal sample based on the event timestamp and the target nearest neighbor algorithm to obtain the distance relationship graph of each signal sample. In other words, graph construction is performed on the obtained data sample by using K-nn, different graphs are constructed according to a sequence for iterative calculation of samples, and the timestamp tᵢ is considered during graph construction, to construct the distance relationship graph among event nodes. Therefore, the distance formula and the K value are determined in the initial nearest neighbor algorithm. In this application, the K value is determined as 5 for selection of a nearest point; and the selected distance formula is a Euclidean distance formula as follows:

$$d ( t , x , y ) = \sqrt{{( {t}_{i} - {t}_{j} )}^{2} + {( {x}_{i} - {x}_{j} )}^{2} + {( {y}_{i} - {y}_{j} )}^{2}}$$

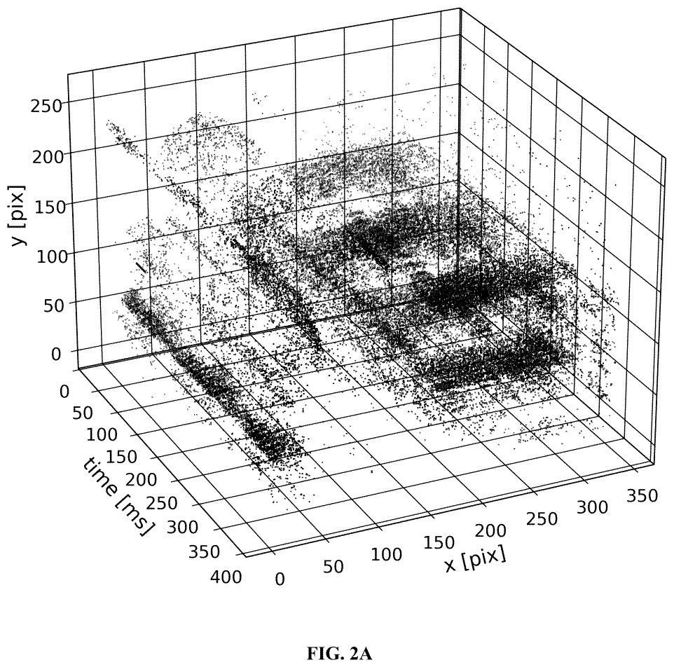

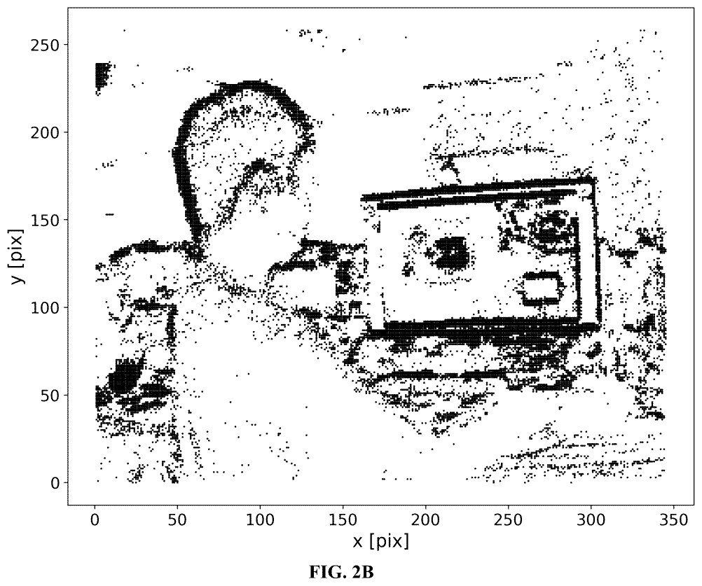

In this embodiment, that density clustering is performed on the distance relationship graph to recognize the target object includes: Density clustering is performed on the distance relationship graph based on a density-based spatial clustering of applications with noise (DBSCAN) algorithm to recognize the target object. To be specific, as shown in FIGS. 2A-2B, the DBSCAN algorithm is determined as a target density clustering algorithm to perform density clustering on the distance relationship graph, and a number of targets recorded by the event camera is recognized through clustering to recognize the target object.

It can be seen that, in this application, the preset visual sensor is used to perform the event signal collection on the target object to obtain the target event signal; the slice division operation is performed on the target event signal based on the preset time interval to obtain the signal sample; and the graph construction operation is performed on the signal sample based on the event timestamp and the target nearest neighbor algorithm to obtain the distance relationship graph of the signal sample, and density clustering is performed on the distance relationship graph to recognize the target object. In other words, event stream data output by the sensor is filtered, slicing at a fixed time interval is performed according to the timestamp, a graph is reconstructed for divided event data to reconstruct an image, and the density clustering algorithm is performed on a reconstructed graph for characteristic clustering of the target object. A density-clustering machine learning algorithm is adopted during target recognition, and recognition on a dynamic target is implemented through iterative calculation at fixed time slices. In this way, a utilization rate of the preset visual sensor can be greatly increased.

In the foregoing embodiment, the entire target recognition method is specifically described. Processes of constructing the distance relationship graph, and the like are specifically described in this application.

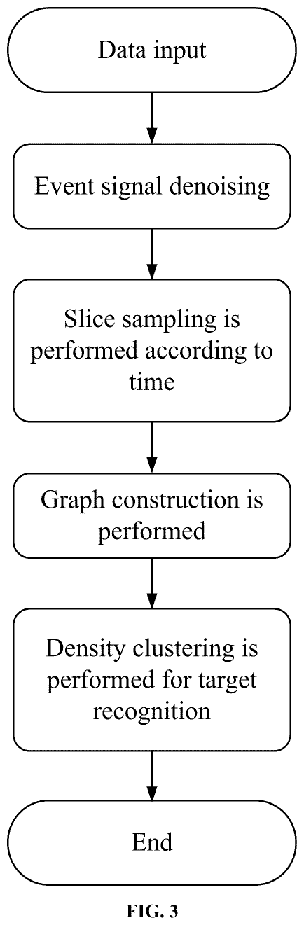

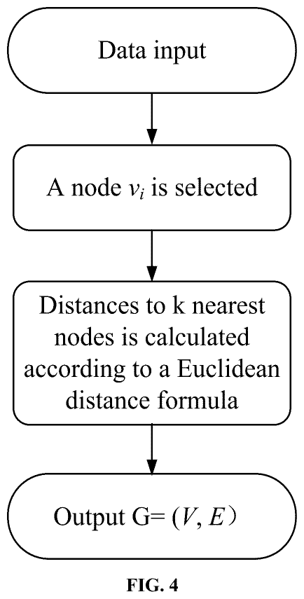

As shown in FIG. 3, an embodiment of this application discloses a specific target recognition method. A computer is connected to an event camera to collect an event, an output event format is converted into readable event data, and the data is denoised to output a list form of the event; and event slicing is performed on the output list form according to a time index, and an overall event is divided into event samples. K-nn time-space domain graph construction is performed on the event sample, to output a distance matrix and an index matrix. To be specific, as shown in FIG. 4, graph construction is performed on the output single sample to construct a graph G=(V, E), and each event point is represented as vᵢ=(tᵢ, xᵢ, yᵢ), where vᵢ is an event node (vᵢ∈V); a time-space domain undirected graph among event nodes is constructed, and a distance relationship among the event nodes is calculated through Knn, to generate a relationship among sides of the graph for outputting a side distance relationship matrix among the event nodes. Density clustering is performed on the output distance matrix, and clustering for a target is implemented by clustering the event nodes, to achieve effect of target recognition. That is, DBSCAN clustering is performed on the output graph G=(V, E), and the density clustering algorithm DBSCAN is performed on the constructed graph for clustering the output side distance matrix, and a clustering type of the event nodes is determined by searching for a density relationship of the sides; and the recognized clustering type of the event nodes is output through a predication label, where a type in the label represents a number of targets captured by the event camera.

In this way, event stream data output by the sensor is filtered, slicing at a fixed time interval is performed according to the timestamp, a graph is reconstructed for divided event data to reconstruct an image, and the density clustering algorithm is performed on a reconstructed graph for characteristic clustering of a target. For the use method, a density-clustering machine learning algorithm is adopted during target recognition, and recognition on a dynamic target is implemented through iterative calculation at fixed time slices. In this way, a utilization rate of the event camera is increased through the target recognition method based on the event signal.

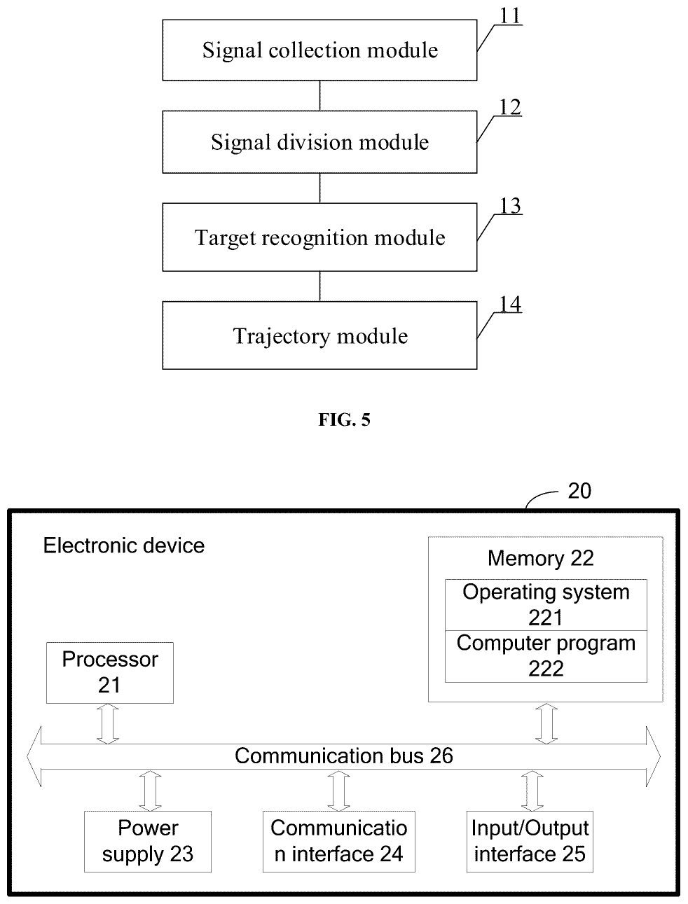

Refer to FIG. 5. An embodiment of this application discloses a target recognition apparatus, including:
a signal collection module 11, configured to perform, by using a preset visual sensor, event signal collection on a target object to obtain a target event signal;
a signal division module 12, configured to perform a slice division operation on the target event signal based on a preset time interval to obtain a signal sample;
a target recognition module 13, configured to: perform a graph construction operation on the signal sample based on an event timestamp and a target nearest neighbor algorithm to obtain a distance relationship graph of the signal sample, and perform density clustering on the distance relationship graph to recognize the target object; and
a trajectory module 14, configured to track the recognized target object by the preset visual sensor to obtain a moving trajectory of the target object after recognizing the target object;
wherein the target object is a moving object.

It can be seen that, according to the target recognition apparatus in this embodiment, the event signal collection is performed on the target object by using the preset visual sensor to obtain the target event signal; the slice division operation is performed on the target event signal based on the preset time interval to obtain the signal sample; and the graph construction operation is performed on the signal sample based on the event timestamp and the target nearest neighbor algorithm to obtain the distance relationship graph of the signal sample, and density clustering is performed on the distance relationship graph to recognize the target object. In other words, slicing at a fixed time interval is performed according to the timestamp, a graph is reconstructed for divided event data to reconstruct an image, and the density clustering algorithm is performed on a reconstructed graph for characteristic clustering of the target object, so that the recognition on the target object is accomplished. In this way, a density-clustering machine learning algorithm is adopted during target recognition, and recognition on a dynamic target is implemented through iterative calculation at fixed time slices, so that a utilization rate of the preset visual sensor is greatly increased.

In some specific embodiments, the signal collection module 11 specifically includes:
an event stream obtaining unit, configured to perform, by using the preset visual sensor, the event signal collection on the target object to obtain a target event stream; and
a data filter unit, configured to: perform data simplification on the target event stream based on event pixel coordinates and the event timestamp to obtain a simplified data signal, and perform data denoising on the simplified data signal to obtain the target event signal.

In some specific embodiments, the signal collection module 11 specifically includes:
an initial signal obtaining unit, configured to perform, by using the preset visual sensor, the event signal collection on the target object to obtain an initial event signal; and
a data format conversion unit, configured to: convert an event format of the initial event signal into a list form, to obtain the target event signal.

In some specific embodiments, the signal division module 12 is specifically configured to: perform the slice division operation on the target event signal based on the preset time interval and along the event timestamp in the target event signal to obtain the signal sample. In some specific embodiments, the target recognition apparatus further includes:
a nearest neighbor algorithm setting module, configured to set a distance formula and a K value in an initial nearest neighbor algorithm to obtain the target nearest neighbor algorithm, where the distance formula is a Euclidean distance formula.

In some specific embodiments, the signal collection module 11 is specifically configured to: sequentially perform the graph construction operation constructed by iterative calculation on each signal sample based on the event timestamp and the target nearest neighbor algorithm to obtain the distance relationship graph of each signal sample.

In some specific embodiments, the target recognition module 13 is specifically configured to: perform density clustering on the distance relationship graph based on a DBSCAN algorithm to recognize the target object.

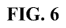

Further, an embodiment of this application further discloses an electronic device. FIG. 6 is a schematic structural diagram of an electronic device 20 according to an example embodiment. Content in the figure cannot be considered as any limitation on a use range of this application.

FIG. 6 is a schematic structural diagram of an electronic device 20 according to an embodiment of this application. The electronic device 20 specifically includes: at least one processor 21, at least one memory 22, a power supply 23, a communication interface 24, an input/output interface 25, and a communication bus 26. The memory 22 is configured to store a computer program, where the computer program is loaded and implemented by the processor 21, to implement related steps in the target recognition method according to any one of the foregoing embodiments. In addition, the electronic device 20 in this embodiment nay be an electronic computer.

In this embodiment, the power supply 23 is configured to provide a working voltage for each hard device on the electronic device 20. The communication interface 24 is configured to create a data transmission channel between the electronic device 20 and an external device, and a followed communication protocol is any communication protocol appliable to the technical solution in this application, which is not specifically limited herein. The input/output interface 25 is configured to obtain externally input data or output data to the outside. A specific interface type can be selected according to a specific application need, and is not specifically limited herein.

In addition, the memory 22 is used as a carrier for resource storage, and may be a read-only memory, a random memory, a magnetic disk, an optical disk, or the like. Resources stored on the memory 22 may include an operating system 221, a computer program 222, and the like, and a storage manner may be transient storage or permanent storage.

The operating system 221 is configured to: manage and control each hard device and the computer program 222 on the electronic device 20, and may be Windows Server, Netware, Unix, Linux, or the like. In addition to including the computer program for completing the target recognition method implemented by the electronic device 20 according to any one of the foregoing embodiments, the computer program 222 may further include a computer program configured to complete other specific work.

Further, this application further discloses a computer-readable storage medium, where the computer-readable storage medium is configured to store a computer program, and when the computer program is executed by a processor, the foregoing target recognition method is implemented. For specific steps of the method, refer to corresponding content in the foregoing embodiments, and details are not described again.

The embodiments in the specification are described in a progressive manner, each embodiment focuses on the difference from other embodiments, and it is sufficient to refer to one another for the same and similar parts among the embodiments. Since an apparatus disclosed in the embodiments corresponds to a method disclosed in the embodiments, its description is relatively simple, and reference can be made to description of the method for relevant contents.

A person skilled in the art may further realize that, the units and the algorithm steps of the examples described in the embodiments of the present disclosure can be implemented by electronic hardware, computer software, or a combination thereof. In order to clearly describe the interchangeability between the hardware and the software, compositions and steps of each example have been generally described according to functions in the foregoing descriptions. Whether the functions are performed by hardware or software depends on particular applications and design constraints of the technical solutions. A person skilled in the art may use different methods to implement the described functions for each particular application, but it should not be considered that the implementation goes beyond the scope of this application.

The steps of the method or algorithm described in the embodiments of the present disclosure may be directly implemented in hardware, in a software module executed by a processor, or in a combination of both. The software module may be disposed on a random memory (RAM), an internal memory, a read-only memory (ROM), an electrically programmable read-only memory (ROM), an electrically erasable programmable read-only memory (ROM), a register, a hard disk, a removable disk, a compact disc read-only memory (CD-ROM), or any other form of storage medium known in the technical field,

Finally, it should be further noted that, in this description, relationship terms such as first and second are only used to distinguish an entity or operation from another entity or operation, but do not necessarily require or imply that there is any actual relationship or order between these entities or operations. In addition, terms “include”, “comprise”, or their any other variations are intended to cover a non-exclusive inclusion, so that a process, a method, an article, or a device including a series of elements not only includes those elements, but also includes other elements that are not explicitly listed, or also includes inherent elements of the process, the method, the article, or the device. In the case that there are no more restrictions, an element limited by the statement “includes a . . . ” does not exclude the presence of additional identical elements in the process, the method, the article, or the device that includes the element.

The connection method and apparatus provided in the present disclosure are described above in detail. Several embodiments are used for illustration of the principles and implementations of the present disclosure. The description of these embodiments is only used to help illustrate the method and its core principles of the present disclosure. In addition, those of ordinary skill in the art can make various modifications in terms of specific implementations and scope of application in accordance with the ideas of the present disclosure. In conclusion, the content of this specification shall not be construed as a limitation to the present disclosure.

What is claimed is:

1. A target recognition method, comprising:
performing, by using a preset visual sensor, event signal collection on a target object to obtain a target event signal;
performing a slice division operation on the target event signal based on a preset time interval to obtain a signal sample;
performing a graph construction operation on the signal sample based on an event timestamp and a target nearest neighbor algorithm to obtain a distance relationship graph of the signal sample, and performing density clustering on the distance relationship graph to recognize the target object; and
tracking the recognized target object by the preset visual sensor to obtain a moving trajectory of the target object;
wherein the target object is a moving object.

2. The target recognition method according to claim 1, wherein the performing, by using a preset visual sensor, event signal collection on a target object to obtain a target event signal comprises:
performing, by using the preset visual sensor, the event signal collection on the target object to obtain a target event stream; and
performing data simplification on the target event stream based on event pixel coordinates and the event timestamp to obtain a simplified data signal, and performing data denoising on the simplified data signal to obtain the target event signal.

3. The target recognition method according to claim 1, wherein the performing, by using a preset visual sensor, event signal collection on a target object to obtain a target event signal comprises:
performing, by using the preset visual sensor, the event signal collection on the target object to obtain an initial event signal; and
converting an event format of the initial event signal into a list form, to obtain the target event signal.

4. The target recognition method according to claim 2, wherein the performing a slice division operation on the target event signal based on a preset time interval to obtain a signal sample comprises:
performing the slice division operation on the target event signal based on the preset time interval and along the event timestamp in the target event signal to obtain the signal sample.

5. The target recognition method according to claim 2, wherein before the performing a graph construction operation on the signal sample based on an event timestamp and a target nearest neighbor algorithm to obtain a distance relationship graph of the signal sample, the method further comprises:
setting a distance formula and a K value in an initial nearest neighbor algorithm to obtain the target nearest neighbor algorithm, wherein the distance formula is a Euclidean distance formula.

6. The target recognition method according to claim 2, wherein the performing a graph construction operation on the signal sample based on an event timestamp and a target nearest neighbor algorithm to obtain a distance relationship graph of the signal sample comprises:
sequentially performing the graph construction operation constructed by iterative calculation on each signal sample based on the event timestamp and the target nearest neighbor algorithm to obtain the distance relationship graph of each signal sample.

7. The target recognition method according to claim 1, wherein the performing density clustering on the distance relationship graph to recognize the target object comprises:
performing density clustering on the distance relationship graph based on a density-based spatial clustering of applications with noise (DBSCAN) algorithm to recognize the target object.

8. A target recognition apparatus, comprising:
a signal collection module, configured to perform, by using a preset visual sensor, event signal collection on a target object to obtain a target event signal;
a signal division module, configured to perform a slice division operation on the target event signal based on a preset time interval to obtain a signal sample;
a target recognition module, configured to: perform a graph construction operation on the signal sample based on an event timestamp and a target nearest neighbor algorithm to obtain a distance relationship graph of the signal sample, and perform density clustering on the distance relationship graph to recognize the target object; and
a trajectory module, configured to track the recognized target object by the preset visual sensor to obtain a moving trajectory of the target object;
wherein the target object is a moving object.

9. An electronic device, comprising:
a memory, configured to store a computer program; and
a processor, configured to execute the computer program to implement the target recognition method according to claim 1.

10. A non-transitory computer-readable storage medium, wherein the computer-readable storage medium is configured to store a computer program, and when the computer program is executed by a processor, the target recognition method according to claim 1 is implemented.

11. The target recognition method according to claim 2, wherein the performing density clustering on the distance relationship graph to recognize the target object comprises:
performing density clustering on the distance relationship graph based on a density-based spatial clustering of applications with noise (DBSCAN) algorithm to recognize the target object.

12. The target recognition method according to claim 3, wherein the performing density clustering on the distance relationship graph to recognize the target object comprises:
performing density clustering on the distance relationship graph based on a density-based spatial clustering of applications with noise (DBSCAN) algorithm to recognize the target object.

13. The target recognition method according to claim 4, wherein the performing density clustering on the distance relationship graph to recognize the target object comprises:
performing density clustering on the distance relationship graph based on a density-based spatial clustering of applications with noise (DBSCAN) algorithm to recognize the target object.

14. The target recognition method according to claim 5, wherein the performing density clustering on the distance relationship graph to recognize the target object comprises:
performing density clustering on the distance relationship graph based on a density-based spatial clustering of applications with noise (DBSCAN) algorithm to recognize the target object.

15. The target recognition method according to claim 6, wherein the performing density clustering on the distance relationship graph to recognize the target object comprises:
performing density clustering on the distance relationship graph based on a density-based spatial clustering of applications with noise (DBSCAN) algorithm to recognize the target object.

16. The electronic device according to claim 9, wherein the performing, by using a preset visual sensor, event signal collection on a target object to obtain a target event signal comprises:
performing, by using the preset visual sensor, the event signal collection on the target object to obtain a target event stream; and
performing data simplification on the target event stream based on event pixel coordinates and the event timestamp to obtain a simplified data signal, and performing data denoising on the simplified data signal to obtain the target event signal.

17. The electronic device according to claim 9, wherein the performing, by using a preset visual sensor, event signal collection on a target object to obtain a target event signal comprises:
performing, by using the preset visual sensor, the event signal collection on the target object to obtain an initial event signal; and
converting an event format of the initial event signal into a list form, to obtain the target event signal.

18. The electronic device according to claim 16, wherein the performing a slice division operation on the target event signal based on a preset time interval to obtain a signal sample comprises:
performing the slice division operation on the target event signal based on the preset time interval and along the event timestamp in the target event signal to obtain the signal sample.

19. The electronic device according to claim 16, wherein before the performing a graph construction operation on the signal sample based on an event timestamp and a target nearest neighbor algorithm to obtain a distance relationship graph of the signal sample, the method further comprises:
setting a distance formula and a K value in an initial nearest neighbor algorithm to obtain the target nearest neighbor algorithm, wherein the distance formula is a Euclidean distance formula.

20. The electronic device according to claim 16, wherein the performing a graph construction operation on the signal sample based on an event timestamp and a target nearest neighbor algorithm to obtain a distance relationship graph of the signal sample comprises:
sequentially performing the graph construction operation constructed by iterative calculation on each signal sample based on the event timestamp and the target nearest neighbor algorithm to obtain the distance relationship graph of each signal sample.
